(19) United States
(12) Patent Application Publication
(10) Pub. No.: US 2016/0231903 A1
(43) Pub. Date: Aug. 11, 2016

(54) Method and device for magnifying webpage on mobile terminal browser

(71) Applicant: ZTE CORPORATION, Guangdong (CN)

(72) Inventor: Gang Cao, Shenzhen (CN)

(21) Appl. No.: 14/907,344

(22) PCT Filed: Nov. 21, 2013
(86) PCT No.: PCT/CN2013/087637

§ 371 Date: Apr. 1, 2016

(30) Foreign Application Priority Data
Jul. 29, 2013 (CN) 201310323534.3

(51) Int. Cl. G06F 3/0484

(52) U.S. Cl. CPC G06F 3/04842; G06F 3/04847

(57) ABSTRACT

A method and device for magnifying a webpage on a browser on a mobile terminal, and the method includes: automatically setting the browse mode of the browser as an overview mode by the browser when a large webpage is opened by a user of the mobile terminal, and when a first region in the large webpage is selected, popping up a webpage magnifier to magnify and display the first region; furthermore, sliding the webpage magnifier to a second region, and magnifying and displaying the second region by the webpage magnifier. In the overview mode, only a region selected by the user is magnified, thereby improving user experience.

### TECHNICAL FIELD

The disclosure relates to the technology for operating a browser in a mobile terminal, and in particular to a method and device for magnifying a webpage on a browser on a mobile terminal.

### BACKGROUND

With the rapid development of wireless communication technologies, more and more users access the Internet using browsers on mobile terminals. As the screen sizes of mobile terminals are limited, it is important for users to have good experience in the use of browsers in the mobile terminals. When a host webpage of a large-scale www website is browsed on a browser of a mobile terminal, as the size of the webpage is quite big while the screen size of the mobile terminal is limited, usually only partial contents of the webpage can be seen, and other contents of the webpage can be browsed only by constantly moving the horizontal and vertical scroll bars. In this way, the overall layout of the webpage cannot be seen as that displayed on a computer terminal.

The overall layout of a large webpage can only be seen on a browser on a mobile terminal by setting the browser as an overview mode, but in the overview mode, the elements, such as a font, a picture and the like, of the webpage are looked quite small. At present, this problem is solved by the browser on the mobile terminal like this: a region in which a user is interested is magnified and displayed through a finger magnification function or by popping up a magnifying box, but when other regions are to be magnified and browsed, a page needs to be continually switched to the original interface of the webpage, causing the user to operate more complicatedly; or, even though the user can magnify and browse the webpage in the overview mode through sliding, when the webpage is magnified and browsed, the webpage is integrally magnified, a screen of the mobile terminal only displays the partial contents of the webpage, and cannot still display the overall layout of the webpage, and the user experience is influenced greatly.

### SUMMARY

In view of this, embodiments of the disclosure are mainly intended to provide a method and device for magnifying a webpage on a browser on a mobile terminal, through which only can a region in which a user is interested be flexibly magnified and browsed, so as to acquire terrific user experience.

To implement the purposes above, a technical solution of the embodiments of the disclosure is implemented as follows.

The method for magnifying a webpage on a browser on a mobile terminal includes:
automatically setting, by the browser, a browse mode of the browser as an overview mode when a large webpage is opened on the mobile terminal; and
selecting a first region in the large webpage, and popping up a webpage magnifier to magnify and display the first region.

In the solution above, the method may further include: sliding the webpage magnifier to a selected second region, and magnifying and displaying the selected second region by the webpage magnifier.

In the solution above, magnifying and displaying the first region by the webpage magnifier may include:
determining that a display mode of a currently opened webpage is an overview mode, moreover, when an operation on the selected first region in the large webpage is determined to be double clicking the webpage for the first time, opening the webpage magnifier, and magnifying and displaying the first region.

In the solution above, magnifying and displaying the first region by the webpage magnifier may include:
taking the region which is double clicked by a user and in which the user is interested as the first region which is selected, translating a centre of first region to a centre of a screen, popping up the webpage magnifier by taking the centre as a benchmark, and magnifying and displaying the first region by the webpage magnifier.

In the solution above, automatically setting, by the browser, the browse mode of the browser as the overview mode may include:
obtaining data after analysis and layout of a currently opened webpage, and when a pixel width of content of the currently opened webpage is determined to be larger than that of a screen of the mobile terminal, calculating a new initial webpage size of the currently opened webpage in the overview mode, and displaying the currently opened webpage as the overview mode according to the calculated and gained new initial webpage size.

In the solution above, magnifying and displaying the first region by the webpage magnifier may further include:
obtaining a corresponding displayed region from webpage layout data according to an obtained coordinate position of a double-clicked point in the screen of the mobile terminal, obtaining a displayed screenshot of the displayed region from a display buffer of the browser, establishing a new view, and magnifying and displaying the displayed screenshot in the newly established view.

In the solution above, magnifying and displaying the second region by the webpage magnifier may include:
obtaining a sliding distance and a sliding time away from a last magnified point, and when the sliding distance and the sliding time are determined to be larger than a preset distance threshold value and a preset time threshold value, magnifying and displaying the content of the second region through the webpage magnifier, and clearing the sliding distance and the sliding time.

Based on the method above, an embodiment of the disclosure further provides a device for magnifying a webpage on a browser on a mobile terminal, which includes: a setting unit, a region selecting unit and a display unit, wherein,
the setting unit is configured to set a browse mode of the browser as the overview mode when the large webpage is opened on the mobile terminal;
the region selecting unit is configured to select a first region in the large webpage, and to pop up the webpage magnifier; and
the displaying unit is configured to magnify and display the selected first region through the webpage magnifier.

In the solution above, the device may further include a sliding unit which is configured to slide the webpage magnifier to a selected second region; and
correspondingly, the display unit is further configured to magnify and display the selected second region through the webpage magnifier.

In the solution above, the setting unit may be configured to obtain data after analysis and layout of a currently opened webpage, and when a pixel width of content of the currently opened webpage is determined to be larger than that of a screen of the mobile terminal, to calculate a new initial webpage size of the currently opened webpage, in the overview mode, and to set the browse mode of the browser as the overview mode according to the calculated and gained new initial webpage size.

In the solution above, the region selecting region may be configured to obtain a corresponding displayed region from webpage layout data according to a coordinate position of a point, which is double clicked by a user, in a screen of the mobile terminal, to obtain a displayed screenshot of the displayed region in a display buffer of the browser, to establish a new view, and to magnify and display the obtained displayed screenshot through the webpage magnifier.

In the solution above, the sliding unit may be configured to obtain a sliding distance and a sliding time away from a last magnified point, and when the sliding distance and the sliding time is determined to be larger than a preset distance threshold value and a preset time threshold value, to magnify and display content of the second region through the webpage magnifier, and to clear the sliding distance and the sliding time.

According to the method and device for magnifying a webpage on a browser on a mobile terminal, which are provided by the embodiments of the disclosure, when a large webpage is opened on the mobile terminal, the browser automatically sets the browse mode thereof as an overview mode; when the first region in the large webpage is selected, the webpage magnifier is popped up to magnify and display the first region;

preferably, the selected second region is magnified and displayed through sliding the webpage magnifier, thus implementing the magnification and display in any region of the opened large webpage through the webpage magnifier in the overview mode, and flexibly magnifying and browsing only the region in which the user is interested, and acquiring the terrific user experience.

### BRIEF DESCRIPTION OF THE DRAWINGS

FIG. 1 is a basic flow diagram showing a method for magnifying a webpage on a browser on a mobile terminal according to an embodiment of the disclosure;

FIG. 2 is a schematic diagram of browsing on a browser of a mobile terminal using a webpage magnifier according to an embodiment of the disclosure;

FIG. 3 is a processing flowchart of self-adaptively setting the overview mode of the webpage according to an embodiment of the disclosure;

FIG. 4 is a processing flowchart of double clicking to control the webpage for magnification according to an embodiment of the disclosure;

FIG. 5 is a processing flowchart of magnifying and display by the webpage magnifier according to an embodiment of the disclosure;

FIG. 6 is a processing flowchart of magnifying and displaying the webpage in the sliding process of the webpage magnifier according to an embodiment of the disclosure; and

FIG. 7 is a structure schematic diagram showing components of a device for magnifying a webpage on a browser on a mobile terminal according to an embodiment of the disclosure.

### DETAILED DESCRIPTION

In an embodiment of the disclosure, when a large webpage is opened on a mobile terminal, a browser automatically sets the browse mode thereof as an overview mode; when a first region in the large webpage is selected, a webpage magnifier is popped up to magnify and display the first region.

Preferably, the webpage magnifier is slid to a second region, the selected second region is magnified and displayed by the webpage magnifier, thereby implementing magnification and display in the any region of the opened large webpage through the webpage magnifier, in the overview mode.

Here, the first region is a region which is selected by a user and in which the user is interested; the second region is another region which is selected by the user and in which the user is interested; the first region and the second region are regions which do not superpose or incompletely superpose, and the first region and the second region are both any regions within a currently opened large webpage.

When magnification and display are performed, the webpage magnifier only magnifies and displays a currently discretionarily selected region, such as the first region or the second region, in the currently opened large webpage, and the content of the opened large webpage outside the currently selected region is still displayed normally.

Here, the selected first region or second region may be a region, which is double clicked by the user and in which the user is interested, serving as a selected region.

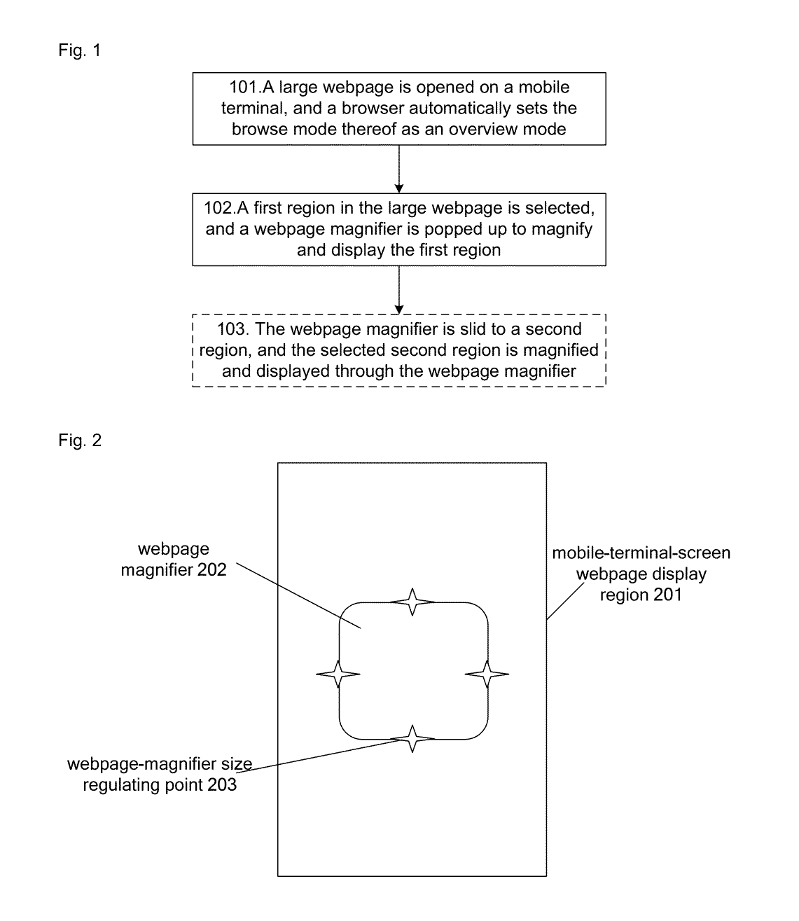

An implementation flow of the method for magnifying a webpage on a browser on a mobile terminal according to an embodiment of the disclosure, as shown in FIG. 1, includes the following steps:

Step 101: the large webpage is opened on the mobile terminal, and the browser automatically sets the browse mode thereof as the overview mode;
here, the large webpage may be a host webpage of a www website, and the like, wherein in order to guarantee that the width of content of a currently opened webpage adapts to the width of the screen of the terminal, the browser automatically sets the browse mode thereof as the overview mode.

Step 102: the first region in the large webpage is selected, and the webpage magnifier is popped up to magnify and display the first region;
here, the first region is the region which is selected by a user and in which the user is interested, and moreover, the user double clicks the region, in which the user is interested, as the selected first region.

Particularly, the browser on the mobile terminal is in the overview mode, the user of the mobile terminal double clicks the region which the user is interested in and serves as the selected first region, the mobile terminal translates the centre of the first region to the centre of a screen, takes the centre as a benchmark and pops up a magnified view, that is, the webpage magnifier; the webpage magnifier magnifies and displays the first region, and the user can click a relevant link on the webpage magnifier to access a new webpage.

Here, the coverage area and magnification ratio of the webpage magnifier can both be preset;

A specific implementation method for clicking a link on the webpage magnifier to access the webpage is the same as a method for directly clicking a relative link on a regular webpage on the mobile terminal to access the new webpage, without being repeated herein.

Preferably, when the user needs to sequentially open any region except the first region in the opened webpage, Step 103 can be carried out.

Step 103: the webpage magnifier is slid to the second region, and the selected second region is magnified and displayed through the webpage magnifier.

Here, the second region is any region in the opened large webpage, except the first region, and the second region is another region in which the user is interested.

Particularly, sliding the webpage magnifier may be implemented through sliding a finger or a touch pen and the like on the webpage magnifier; when a sliding position exceeds a screen window of the mobile terminal, a corresponding horizontal or vertical scroll bar automatically scrolls along with the webpage magnifier; in the sliding process of the webpage magnifier, the webpage magnifier will magnify regions, through which the webpage magnifier passes, in real time; when the user does not need a magnification function, the user can double click the webpage magnifier to close the webpage magnifier.

It is to be noted that, in a display screen of the mobile terminal, contents in the coverage area of the webpage magnifier are magnified and displayed, but contents outside the coverage area of the webpage magnifier are all normally displayed.

In the embodiment of the disclosure, the size of the webpage magnifier needs to be less than a screen size, so as to meet that the user can see other non-magnified regions around at the same time when magnifying and browsing the selected region; the user can also slide a size regulating point on the webpage magnifier to further regulate the size of the webpage magnifier according to the requirement of the user.

The technical solution of the disclosure is further illustrated in detail below in conjunction with drawings and the specific embodiment.

In the embodiment of the disclosure, an interface of the browser on the mobile terminal is moved by utilizing the webpage magnifier, as shown in FIG. 1, the interface includes a mobile-terminal-screen webpage display region 201, a webpage magnifier 202, and a webpage-magnifier size regulating point 203, wherein
the mobile-terminal-screen webpage display region 201 is a visual area, which is displayed in the mobile terminal, of an opened large webpage;
the webpage magnifier 202 is configured to magnify and display the content in the coverage area thereof, and a user can discretionarily slide the webpage magnifier in the mobile-terminal-screen webpage display region 201 through sliding the webpage magnifier 202;

Generally, there are at least four webpage-magnifier size regulating points 203, serving as identification points for adjusting the size of the webpage magnifier 202 and corresponding to four directions; the user can change the size of the webpage magnifier 202 through sliding the webpage-magnifier size regulating points 203, so as to implement the zooming of the coverage area of the webpage magnifier.

To implement the functions of the webpage magnifier in FIG. 2, the following four key links need to be completed: the self-adaptive setting of the overview mode of the webpage, the control processing of double click of the webpage for magnification, the magnification and display of the content of the region selected by the user, in the webpage magnifier, and the processing of magnification of the webpage in the sliding process of the webpage magnifier. The implementation flow of each key link will be illustrated below in detail respectively in conjunction with the drawings.

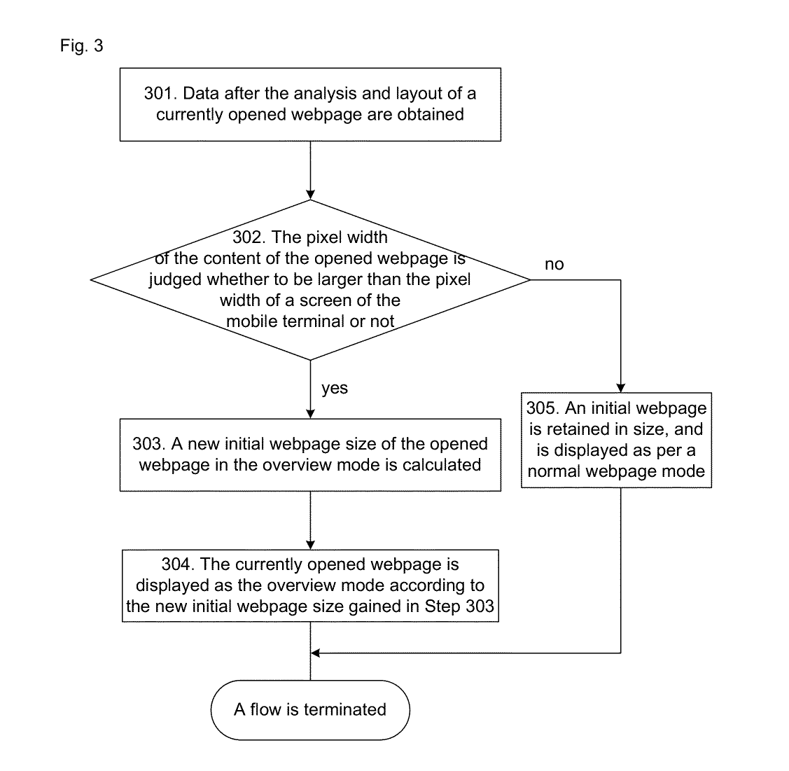

The webpage magnifier is mainly applied to the overview mode of a large www webpage, but a webpage with a few contents thereof in a small mobile terminal does not need to be set as the overview mode, therefore, when the large webpage is opened, the mobile terminal needs to self-adaptively determine whether the webpage needs to be set to the overview mode or not, and the processing flow of self-adaptively setting the overview mode of the webpage, as shown in FIG. 3, includes the following steps:

Step 301: data after the analysis and layout of the currently opened webpage are obtained;

Here, the data include the pixel width and the pixel height of the content of the webpage, the default initial size of the webpage, the data needed to be displayed on the webpage, and the like; how to obtain the corresponding data particularly belongs to the conventional art, without repeating herein.

Step 302: the pixel width of the content of the opened webpage is determined whether to be larger than the pixel width of the screen of the mobile terminal or not, if YES, Step 303 is carried out; if NO, Step 305 is carried out;

Step 303: the new initial webpage size of the opened webpage in the overview mode is calculated;

Particularly, a method for calculating the new initial webpage size of the webpage in the overview mode can be that: an initial webpage size in the overview mode is equal to the result of dividing the pixel width of the screen of the mobile terminal by the pixel width of the content of the webpage.

Step 304: the currently opened webpage is displayed as the overview mode according to the new initial webpage size gained in Step 303; and

Step 305: an initial webpage is retained in size, and is displayed in a normal webpage mode.

Here, when the large www webpage is displayed in the overview mode, the user is convenient for wholly browsing the content of the webpage; when being interested in some region in the opened large webpage, the user can magnify and browse the region. In consideration of that singly clicking the webpage is generally an operation of clicking the link to access the new webpage, therefore, double clicking the webpage in the embodiment of the disclosure is defined as an action of magnifying the webpage.

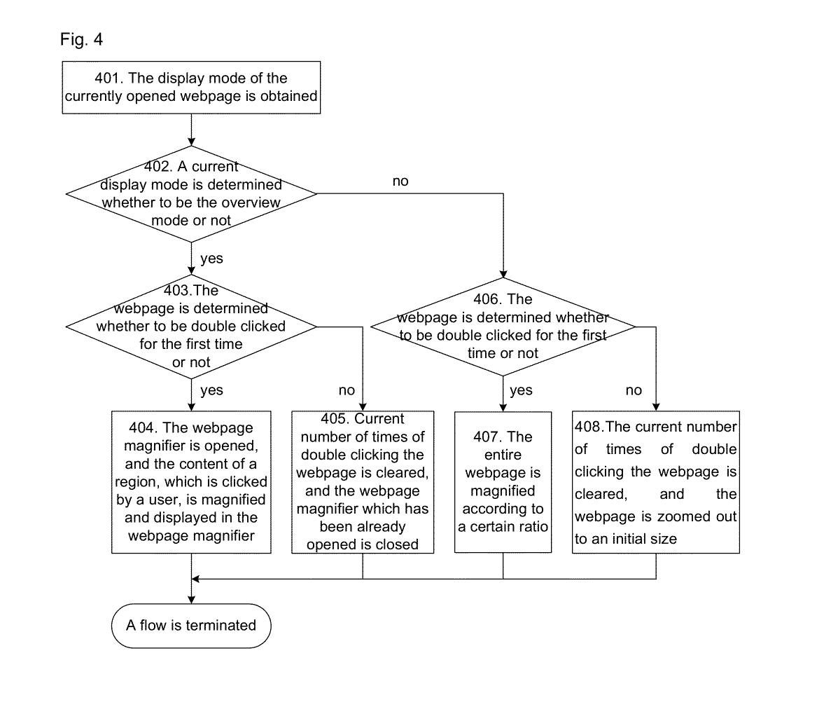

Particularly, the processing flow of double clicking to control the webpage for magnification, as shown in FIG. 4, includes the following steps:

Step 401: the display mode of the currently opened webpage is obtained;

Here, how to obtain the display mode of the currently opened webpage belongs to the conventional art, without being repeated herein.

Step 402: a current display mode is determined whether to be the overview mode or not; if it is the overview mode, Step 403 is carried out, and if not, Step 406 is carried out;

Step 403: the webpage is determined whether to be double clicked for the first time or not, if it is double clicked for the first time, Step 404 is carried out, and if not, Step 405 is carried out;

Step 404: the webpage magnifier is opened, the content of the region clicked by the user is magnified and displayed in the webpage magnifier, and a current processing flow is terminated;

Here, the magnification ratio and coverage area of the webpage magnifier can be both set previously by the user according to a requirement.

Step 405: the current number of times of double clicking the webpage is cleared, the webpage magnifier which has been already opened is closed, and a current processing flow is terminated;

Step 406: the webpage is determined whether to be double clicked for the first time or not; if it is double clicked for the first time, Step 407 is carried out, and if not, Step 408 is carried out;

Step 407: the entire webpage is magnified according to a certain ratio, and a current processing flow is terminated;

Here, the certain ratio can be preset by the user according to the requirement.

Step 408: the current number of times of double clicking the webpage is cleared, and the webpage is zoomed out to the initial size.

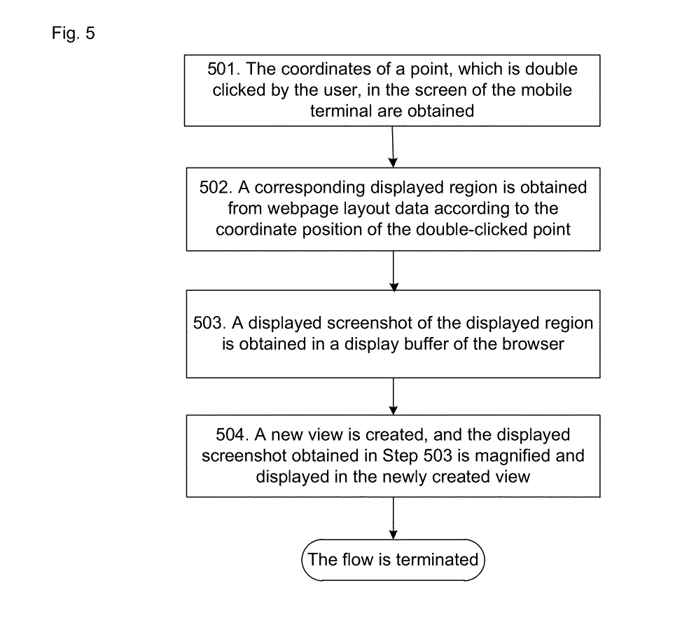

In the embodiment of the disclosure, the webpage magnifier is a new view, and magnifies and displays the content of the region which is double clicked by the user in the webpage in the new view, and the processing flow of magnifying and displaying the user-clicked region through the webpage magnifier, as shown in FIG. 5, includes the following steps:

Step 501: the coordinates of the point, which is double clicked by the user, in the screen of the mobile terminal are obtained;

Step 502: the corresponding displayed region is obtained from the webpage layout data according to the coordinate position of the double-clicked point;

In the embodiment of the disclosure, a minimum displayed region corresponding to the coordinate position of the double-clicked point can be adopted for the displayed region.

Step 503: the displayed screenshot of the displayed region is obtained from the display buffer of the browser;

In the embodiment of the disclosure, the displayed region is the initial display coverage area of the webpage magnifier.

Step 504: a new view is created, and the displayed screenshot obtained in Step 503 is magnified and displayed in the newly created view.

Here, the newly created view is the webpage magnifier.

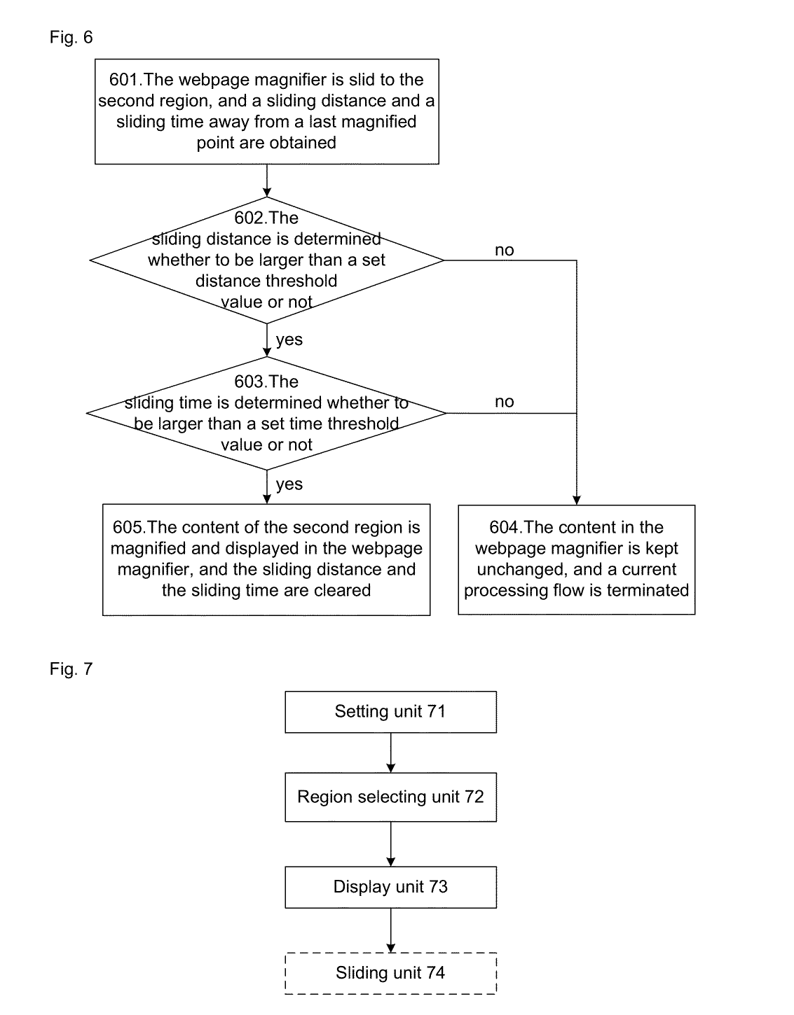

In the embodiment of the disclosure, any region of the opened webpage can be magnified through sliding the webpage magnifier, as if the user uses a virtual a webpage magnifier on the webpage. The processing flow of magnifying the webpage in the sliding process of the webpage magnifier, as shown in FIG. 6, includes the following steps:

Step 601: the webpage magnifier is slid to the second region, and the sliding distance and the sliding time away from the last magnified point are obtained;

Here, the magnified point refers to the centre point of the webpage magnifier before the sliding.

Step 602: the sliding distance is determined whether to be larger than the preset distance threshold value or not; if it is larger than the preset distance threshold value, step 603 is carried out, and if not, Step 604 is carried out;

Step 603: the sliding time is determined whether to be larger than the preset time threshold value or not; if it is larger than the preset time threshold value, Step 605 is carried out, and if not, Step 604 is carried out;

Step 604: the content in the webpage magnifier is kept unchanged, and a current processing flow is terminated; and

Step 605: the content of the second region is magnified and displayed in the webpage magnifier, and the sliding distance and the sliding time are cleared.

In the flow above, the sliding distance threshold value and the sliding time threshold value can be dynamically set according to the screen size of the mobile terminal and the size of the webpage magnifier, so as to avoid carrying out a magnifying operation too frequently in the sliding process, thereby not influencing the performance of the browser.

In order to implement the method for magnifying a webpage on a browser on a mobile terminal, an embodiment of the disclosure further provides a device for magnifying a webpage on a browser on a mobile terminal, and as shown in FIG. 7, the device includes a setting unit 71, a region selecting unit 72 and a display unit 73, wherein
the setting unit 71 is configured so that the browser automatically sets the browse mode thereof as an overview mode when a large webpage is opened on the mobile terminal;

Here, the setting unit 71 is particularly configured to obtain data after analysis and layout of the currently opened webpage, and when the pixel width of the content of the opened webpage is determined to be larger than the pixel width of the screen of the mobile terminal, to calculate the new initial webpage size of the opened webpage in the overview mode, and to display the currently opened webpage as the overview mode according to the calculated and gained new initial webpage size.

The region selecting unit 72 is configured to select the first region in the large webpage, and to pop up the webpage magnifier;

Here, the first region is the region which is selected by the user and in which the user is interested, and moreover, the user double clicks the region, in which the user is interested, as the selected first region;

Here, the region selecting unit 72 is configured to obtain the corresponding displayed region from the webpage layout data according to the coordinate position of the point, which is double clicked by the user, in the screen of the mobile terminal, to obtain the corresponding displayed region from the webpage layout data, to obtain the displayed screenshot of the displayed region from the display buffer of the browser, to create a new view, and to magnify and display the obtained displayed screenshot in the webpage magnifier;

Here, the displayed region is the initial display coverage area of the webpage magnifier.

The display unit 73 is configured to magnify and display the selected first region through the webpage magnifier;

Preferably, the device may further include a sliding unit 74;

The sliding unit 74 is configured to slide the webpage magnifier to the selected second region;

Correspondingly, the display unit 73 is further configured to magnify and display the selected second region through the webpage magnifier.

Here, the sliding unit 74 is configured to obtain the sliding distance and the sliding time away from the last magnified point, and when the sliding distance and the sliding time are determined to be larger than the preset distance threshold value and time threshold value, to magnify and display the content of the second region in the webpage magnifier, and to clear the sliding distance and the sliding time.

In practical applications, the setting unit 71, the region selecting unit 72, the display unit 73 and the sliding unit 74 can be all implemented by a Central Processing Unit (CPU), or a Digital Signal Processor (DSP), or a Field Programmable Gate Array (FPGA) and the like; the CPU, the DSP and the FPGA can be all embedded in the mobile terminal.

The above are only the preferred embodiments of the disclosure and not intended to limit the scope of the disclosure.

what is claimed is:

1. A method for magnifying a webpage on a browser on a mobile terminal, comprising:
automatically setting a browse mode of the browser as an overview mode by the browser when a large webpage is opened on the mobile terminal; and
selecting a first region in the large webpage, and popping up a webpage magnifier to magnify and display the first region.

2. The method for magnifying a webpage on a browser on a mobile terminal according to claim 1, wherein the method further comprises: sliding the webpage magnifier to a second region which is selected, and magnifying and displaying the second region by the webpage magnifier.

3. The method for magnifying a webpage on a browser on a mobile terminal according to claim 1, wherein magnifying and displaying the first region by the webpage magnifier comprise:
determining that a display mode of a currently opened webpage is an overview mode, and moreover, when an operation on the first region in the large webpage is determined to be double clicking the webpage for the first time, opening the webpage magnifier and magnifying and displaying the first region.

4. The method for magnifying a webpage on a browser on a mobile terminal according to claim 1, wherein magnifying and displaying the first region by the webpage magnifier comprise:
taking a region, which is double clicked by a user and in which the user is interested, as the first region which is selected, translating a centre of the first region to a centre of a screen, popping up the webpage magnifier by taking the centre as a benchmark, and magnifying and displaying the first region by the webpage magnifier.

5. The method for magnifying a webpage on a browser on a mobile terminal according to claim 1, wherein setting the browse mode of the browser as the overview mode by the browser comprises:
obtaining data after analysis and layout of a currently opened webpage, and when a pixel width of content of the currently opened webpage is determined to be larger than a pixel width of a screen of the mobile terminal, calculating a new initial webpage size of the currently opened webpage in the overview mode, and displaying the currently opened webpage as the overview mode according to the calculated and gained new initial webpage size.

6. The method for magnifying a webpage on a browser on a mobile terminal according to claim 1, wherein magnifying and displaying the first region by the webpage magnifier further comprise:
obtaining a corresponding displayed region from webpage layout data according to an obtained coordinate position of a double clicked point in the screen of the mobile terminal, obtaining a displayed screenshot of the displayed region from a display buffer of the browser, establishing a new view, and magnifying and displaying the displayed screenshot in the newly established view.

7. The method for magnifying a webpage on a browser on a mobile terminal according to claim 2, wherein magnifying and displaying the second region by the webpage magnifier comprise:
obtaining a sliding distance and a sliding time away from a last magnified point, and when the sliding distance and the sliding time are determined to be larger than a preset distance threshold value and a preset time threshold value, magnifying and displaying content of the second region through the webpage magnifier, and clearing the sliding distance and the sliding time.

8. A device for magnifying a webpage on a browser on a mobile terminal, comprising: a setting unit, a region selecting unit and a display unit, wherein
the setting unit is configured to set a browse mode of the browser as an overview mode when a large webpage is opened on the mobile terminal;
the region selecting unit is configured to select a first region in the large webpage, and to pop up a webpage magnifier; and
the display unit is configured to magnify and display the selected first region through the webpage magnifier.

9. The device for magnifying a webpage on a browser on a mobile terminal according to claim 8, further comprising a sliding unit which is configured to slide the webpage magnifier to a selected section region; and
correspondingly, the display unit is further configured to magnify and display the selected second region through the webpage magnifier.

10. The device for magnifying a webpage on a browser on a mobile terminal according to claim 8, wherein the setting unit is configured to obtain data after analysis and layout of a currently opened webpage, and when a pixel width of content of the currently opened webpage is determined to be larger than a pixel width of a screen of the mobile terminal, to calculate a new initial webpage size of the currently opened webpage in the overview mode, and to set the browse mode of the browser as the overview mode according to the calculated and gained new initial webpage size.

11. The device for magnifying a webpage on a browser on a mobile terminal according to claim 8, wherein the region selecting unit is configured to obtain a corresponding displayed region from webpage layout data according to a coordinate position of a point, which is double clicked by a user, in a screen of the mobile terminal, to obtain a displayed screenshot of the displayed region in a display buffer of the browser, to establish a new view, and to magnify and display the obtained displayed screenshot through the webpage magnifier.

12. The device for magnifying a webpage on a browser on a mobile terminal according to claim 8, wherein the sliding unit is configured to obtain a sliding distance and a sliding time away from a last magnified point, and when the sliding distance and the sliding time is determined to be larger than a preset distance threshold value and a preset time threshold value, to magnify and display content of the second region through the webpage magnifier, and to clear the sliding distance and the sliding time.
